(19) United States
(12) Patent Application Publication
(10) Pub. No.: US 2018/0196999 A1
(43) Pub. Date: Jul. 12, 2018

(54) METHOD TO ANALYZE A PROFILE OF MOVEMENT

(71) Applicant: FORD GLOBAL TECHNOLOGIES, LLC, Dearborn, MI (US)

(72) Inventor: Carsten STARKE, Vaals (NL)

(73) Assignee: FORD GLOBAL TECHNOLOGIES, LLC, Dearborn, MI (US)

(21) Appl. No.: 15/865,830

(22) Filed: Jan. 9, 2018

(30) Foreign Application Priority Data
Jan. 9, 2017 (DE) 10 2017 200 193.3

(51) Int. Cl. G06K 9/00

(52) U.S. Cl. CPC G06K 9/00335; G06K 9/00825; G06K 9/00369

(57) ABSTRACT

A method to analyze and compare different profiles of movement of at least one road user is provided. A device capable of data acquisition is allocated to the at least one road user. The data are conveyed from the device to a server that determines, depending on a selected possibility of locomotion, comparison data with respect to a same road user or a number of road users, and provides the comparison data to the road user or road users.

### CROSS-REFERENCE TO RELATED APPLICATIONS

This application claims foreign priority benefits under 35 U.S.C. § 119(a)-(d) to DE Application 10 2017 200 193.3 filed Jan. 9, 2017, which is hereby incorporated by reference in its entirety.

### TECHNICAL FIELD

The disclosure relates to a method to analyze and compare various profiles of movement of at least one road user, to whom a device capable of data acquisition is allocated, which are sent to a server.

### BACKGROUND

Modern traffic conditions, in which a high number of road users are moving, require an evaluation of an effectiveness of locomotion of the road users. In this context, there is a number of different locomotion possibilities, especially in urban regions. Furthermore, a number of alternative routes of travel exists in urban regions. In the case of road users, there is frequent motivation to optimize a type of locomotion temporally and spatially, i.e. to reach a target as rapidly as possible and also to travel the shortest possible distance. If nothing else, there is frequently a certain tendency between various road users to compete, which can also entail negative impacts for other road users.

The object exists to enable a comparison of movements of road users.

### SUMMARY

The object is achieved by a method having the features of claim 1. Further advantageous embodiments of the disclosure result from the secondary claim and the subclaims, the figures and the exemplary embodiments.

A first aspect of the disclosure relates to a method to analyze and compare various profiles of movement of at least one road user, to whom a device capable of data acquisition is allocated, which are sent to a server, comprising the steps:
selection of a possibility of locomotion by the road user,
locomotion of the road user from a starting point to a target point,
acquisition of a value of at least one parameter by the device over an entire period of locomotion between starting and target point,
sending the parameter value to the server,
depositing the parameter value in a first list on the server,
comparing the parameter value with other values of the same parameter that are deposited in the first list to generate a comparison value,
depositing the comparison value in a second list on the server,
reporting a result of the comparison value to the road user.

The method is advantageous because it enables the most effective way of locomotion to be determined. By using a connection of the device capable of data acquisition with the server, values of a parameter can be recorded and compared directly with older values of the same parameter. Advantageously, various parameters can be included in the generation of a profile of movement of the road user, with a number of parameters being arbitrary. The type of possibility of locomotion is also reported by the device capable of data acquisition.

Preferably, detected values are compared with values of the same road user in the method. With the connection of the device capable of data acquisition to the server, values of a parameter can be recorded and compared directly with older values of the same parameter that had been achieved by the same road user. In this context, temporally different recordings can be advantageously compared with one another. In this way, the most effective possibility of locomotion can be determined for a person. A person can manage the same distance, for example, on foot, using a bicycle, using a motorcycle, a motor vehicle, wherein the most effective possibility of locomotion can be determined for the same distance for the same person also taking into consideration, naturally, various times at which the data have been recorded. Furthermore, a person can also compete with themselves, that is to say attempt time and again to achieve optimum values and, in doing so, manage the same distance using different or also the same possibilities of locomotion. It is particularly advantageous in this context that a starting point and a target point of a movement can take place in the sense of a door-to-door movement so that, e.g. in the case of a motor vehicle, a search for a parking place is included in a parameter of time needed for a particular distance.

Furthermore, it is preferred if, in the method, values of different road users are compared with one another. In this context, a competition can be advantageously performed between road users using a same method of transport or a different method of transport, the most effective user can be determined with respect to one or more parameters without the users being directly in competition with one another on the road. In addition, different methods of transport of the same type can be compared with one another in this way, e.g. motor vehicles which, however, are of different type, i. e. a sport-utility vehicle and a sedan. The parameters then relate to, e.g., the speed or a consumption of fuel.

The parameter is preferably related to a person being the road user. This means that the parameter or parameters recorded are directly associated with the person who is moving in traffic. The parameters are then selected from a group that comprises an age of the person, a weight of the person, a time needed for a particular distance, selected route and maximum speed. Advantageously, the person can also be traveling on foot.

Furthermore, it is also preferred if the parameter is related to a selected possibility of locomotion. Particularly preferably, a vehicle is selected as a possibility of locomotion. The parameters are selected from a group that comprises a type of vehicle, a time needed for a particular distance, a fuel consumption for a particular distance, a distance traveled, a maximum speed, and standing times of the vehicle and additional passengers in the vehicle. The type of vehicle is preferably a motor vehicle. In this context, person-related parameters can also be included with the parameters related to the possibility of locomotion. Standing times of the vehicle in this case refer to a time in which the vehicle is on a path, but is not currently moving ahead, e.g. in a traffic jam or at the traffic light by which a period of traveling is influenced.

Preferably, a profile of the road user is generated in the method and, on the basis of comparisons of different parameter values, an optimum profile of the road user is calculated. With the optimum profile, tips can be advantageously created for the road user, to change particular parameters in order to, e.g., save fuel at the same speed or to find an optimum method of transportation for a particular route.

A ranking list is preferably generated on the basis of the parameter values determined. The ranking list can be based on various values of a same road user so that the user is in competition with himself. Furthermore, the ranking list can also be kept between different road users.

A second aspect of the disclosure relates to a system to carry the method according to the disclosure, comprising at least one device, allocated to the road user, for data acquisition and at least one server in which the device is configured to send data to the server and to receive data from the server.

The advantages of the system the system according to the disclosure correspond to the advantages of the method according to the disclosure.

The device preferably comprises a chip or an app.

The disclosure is explained in greater detail with the Figures.

### BRIEF DESCRIPTION OF THE DRAWINGS

FIG. 1 shows a block diagram of an embodiment of the system according to the disclosure;

FIG. 2 shows a block diagram of an embodiment of the system according to the disclosure; and

FIG. 3 shows a flowchart of an embodiment of the method according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

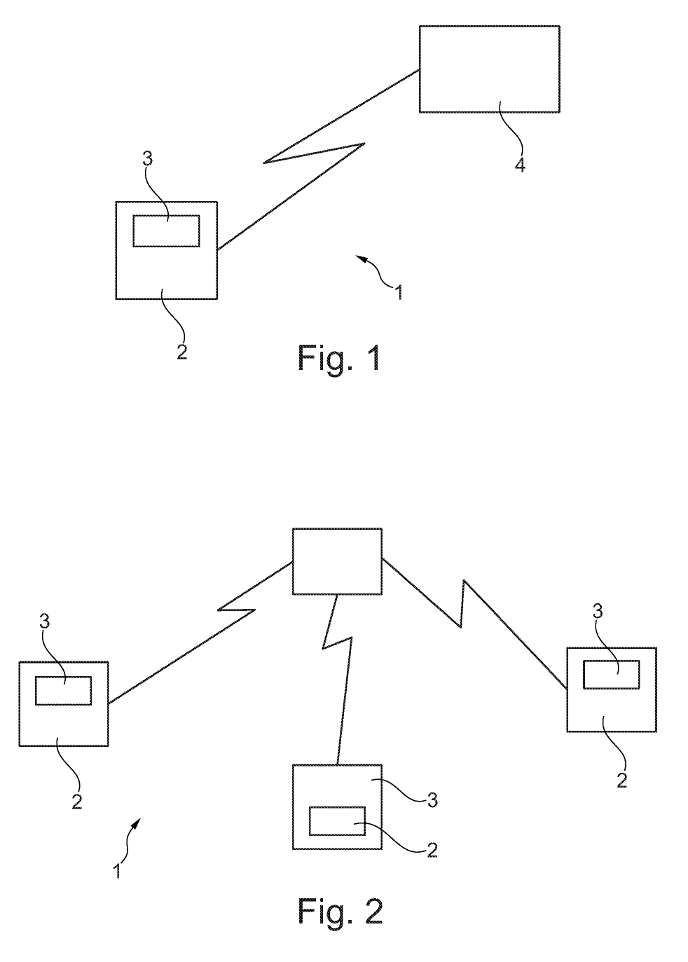

In one embodiment of the system 1 according to the disclosure, according to FIG. 1, a road user 2 is connected with a server 4. For this purpose, the road user 2 is allocated a device capable of data acquisition 3. The road user 2 can be a pedestrian. The road user 2 can move by mobile methods, e.g. on in-line skates. The road user 2 can also move by swimming or boating, that is to say in a manner committed to a waterway. The road user 2 can be a driver of a vehicle, that is to say guide a vehicle actively. In particular, the vehicle is an engine-based vehicle, that is to say a motor vehicle. Alternatively, the vehicle in this context can also be another land vehicle, e.g. a bicycle or a horse-drawn carriage. Furthermore, the vehicle can also be a rail vehicle, a water vehicle or an aircraft, wherein these vehicles can be engine-based or alternatively also provide for locomotion without engine. The road user 2 can also be located in a vehicle and allow himself to be transported passively, e.g. in a bus.

Via the device 3, data are recorded and forwarded to the server 4. The data are recorded and sent continuously during a locomotion of the road user 2 from a starting point to a target point so that the road user 2 is tracked, as it were.

In this context, the device 3 can be, for example, a chip, such as a microprocessor, or an app of a smartphone. In this way, information such as, for example, a selected possibility of locomotion can be input, e.g. via a touch screen of the smartphone. In this way, the device 3 can be carried comfortably, e.g. by a pedestrian, a swimmer or a cyclist. Certain data are person-related, e.g. age and gender of the road user 2, speed, time needed for a particular distance and a selected route.

In the case of engine-based vehicles, e.g. motor vehicles, the device capable of data acquisition 3 is ideally connected to on-board sensors so that vehicle-related data such as, e.g., fuel consumption, number of vehicle passengers and vehicle type are detected and sent to the server 4. Data that are related to the vehicle can be combined readily with person-related data. Some data such as, e.g., speed, are both person- and vehicle-related. For messages or inputs of information, the device 3 allocated to the road user 2 can be implemented either in a mobile device such as e.g. a smartphone or a device of the vehicle, e.g. the touch screen of a navigation device.

In one embodiment of the system 1 according to the disclosure, according to FIG. 2, three road users 2 are connected with the server 4. The number three is here illustrative, an arbitrary number of road users 2 can also be connected with the server 4 as an alternative. The road users 2 can be categorized as described above. The road users 2 can all belong to a same category, e.g. all be pedestrians, all be cyclists or all motor vehicle drivers. However, the road users 2 can also belong to different categories so that, e.g., profiles of cyclists can be compared with those of motor vehicle drivers.

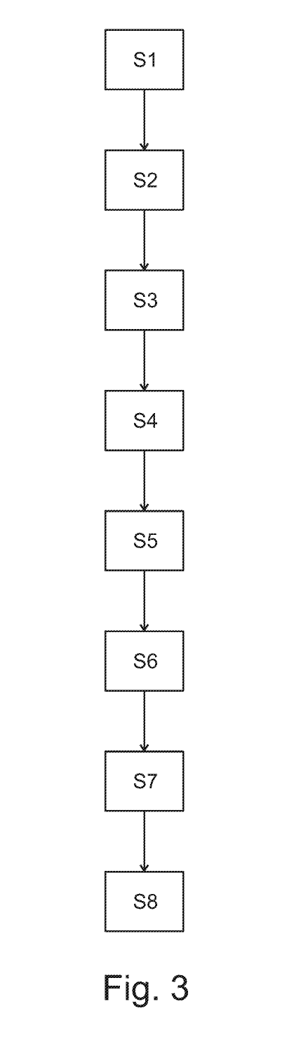

In an embodiment of the method according to the disclosure, according to the representation of FIG. 3, different profiles of movement of at least one road user 2 are analyzed and compared. The road user 2 is allocated a device capable of data acquisition 3. To evaluate the data, the device 3 is configured to send the data to a server 4. In a first step S1, a possibility of locomotion by the road user 2 is selected and conveyed to the device 3, e.g. via an input on a touch screen. In a second step S2, the road user 2 moves from a starting point to a target point. In this context, the road user 2 can start movement directly at the starting point, i.e. start a movement, and end it at the target point, i.e. stop the movement. As a starting point, a point on a route can also be used on which the road user 2 is already moving. A point on the route behind which the movement of the road user 2 extends farther can also be used as the target point. An evaluated distance can thus be assessed arbitrarily from a greater distance completed by the road user 2.

In a third step S3, a value of at least one parameter is detected by the device 3 over an entire period of locomotion between the starting point and the target point. A parameter is, e.g., a time that is measured for a distance from the starting point to the target point. In a fourth step S4, the measured parameter value is sent to the server 4. In a fifth step S5, the parameter value sent is deposited in a first list on the server 4. In the first list, values of a same parameter are deposited, the parameter values being able to originate from the same road user 2 or from different road users 2. In a sixth step S6, the parameter values deposited last are compared with other values of the same parameter that are already deposited in the first list. On the basis of a comparison, reference values are determined that are deposited in a second list on the server 4 in a seventh step. In an eighth step S8, a result of the comparison is reported to the road user 2. For this purpose, corresponding data are sent by the server 4 to the device 3, which reports the result to the road user 2 via a display, e.g. a smartphone.

In one embodiment of the method, values of a number of different parameters are recorded. Recorded parameters can be subdivided into person-related parameters and related to a selected possibility of locomotion and, in this context, evaluated within these categories. Alternatively, all parameters can be evaluated jointly. Person-related parameters are allocated to the road user 2 independently of a type of the selected possibility of locomotion, e.g. an age of the person, a weight of the person, a time needed for a particular distance, a selected route, and a maximum speed reached on the route. Parameters related to the selected possibility of locomotion comprise a type of vehicle, a time needed for a particular distance, a fuel consumption for a particular distance, a distance traveled, a maximum speed, and additional passengers in the vehicle.

In one embodiment of the method, a profile of a relevant road user 2 is generated based on the parameters. In this context, at least one parameter is included in the profile, e.g. the time needed for a particular path distance. However, preferably, a number of parameters are included in the profile. With including a number of parameters in the profile, the profile can be optimized on the basis of the number of parameters. For example, the time needed for a particular route distance of the road user 2 can be reduced in that a particular possibility of locomotion is selected, i.e. a particular method of transportation.

In this context, it is essential in the sense of the disclosure how the starting point and the target point of the route are selected. For example, the starting point is a front door of the residence of a road user 2. The target point is a door of the building in which the road user 2 has their job. Thus, data of an actual door-to-door movement are recorded. The road user 2 can travel once by bicycle and once by car. With respect to the time needed for the distance, factors such as, e.g., a search for a parking space for the car also play a role in this context so that the road user 2 himself, with at least partially higher speed of the car, needs less time for the distance from door to door than with the bicycle. If the same possibility of locomotion is selected by the road user 2, the actual route, e.g., can also be optimized, which is needed for the distance from door to door.

In a further embodiment of the method, a competition between different road users 2, i.e. at least two, with one another can be carried out without them directly racing one another. For this purpose, data of the road users 2 are sent to the server 4 by the device 3. The server 4 determines comparative data, and a ranking list is generated and conveyed to the users. In this context, it is not only times for a particular distance that are compared, but, in the case of motor vehicles, also the highest fuel consumption.

Apart from sporting competition, the method is also used to carry out a comparison between different motor vehicle types. In this context, vehicle-related parameters, in particular, are compared with one another, e.g. consumption of fuel, switching characteristics, maximum speed and the like.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method to analyze and compare different profiles of movement of at least one road user comprising:
allocating a device capable of sending and receiving data from a server;
selecting a possibility of locomotion by the road user;
locomoting(moving) the road user from a starting point to a target point;
acquiring a parameter value by the device over an entire period of movement between the starting and target points;
sending the parameter value to the server;
depositing the parameter value in a first list on the server;
comparing the parameter value with other values of a same parameter being deposited in the first list to generate a comparison value;
depositing the comparison value in a second list on the server; and
reporting a result of the comparison value to the road user.

2. The method as claimed in claim 1 further comprising comparing parameter value with values of a same road user.

3. The method as claimed in claim 1 further comprising comparing parameter values of different road users with one another.

4. The method as claimed in claim 1, wherein the parameter value is related to the road user.

5. The method as claimed in claim 4 further comprising selecting a parameter value as including an age of the road user, a weight of the road user, a time needed for a particular distance, a selected route, or a maximum speed.

6. The method as claimed in claim 1, wherein the parameter value is related to selecting the possibility of locomotion.

7. The method as claimed in claim 6, wherein selecting the possibility of locomotion includes selecting a vehicle.

8. The method as claimed in claim 7 further comprising selecting the parameter value as including a type of vehicle, a time needed for a particular distance, a fuel consumption for a particular distance, a distance traveled, a maximum speed, vehicle standing times, or additional passengers in the vehicle.

9. The method as claimed in claim 1 further comprising generating a profile of the road user, and, based on comparisons of different parameter values, calculating an optimal profile of the road user.

10. The method as claimed in claim 1 further comprising generating a ranking list based on the parameter values.

11. A system, comprising:
a device, allocated to a driver, configured to send and receive data with a server; and
a server, wherein responsive to a locomotion possibility, the server is configured to, in response to a value acquired over a movement period between starting and target points, compare the value with other values deposited on a first list to report, from a second list, a comparison value to the device.

12. The system as claimed in claim 11, wherein the device is a chip.

13. The system as claimed in claim 11, wherein the value is an age of the driver, a weight of the driver, a time needed for a particular distance, a selected route, or a maximum speed.

14. The system as claimed in claim 11, wherein selecting the locomotion possibility is a vehicle.

15. The system as claimed in claim 14, wherein the value is a type of vehicle, a time needed for a particular distance, a fuel consumption for a particular distance, a distance traveled, a maximum speed, vehicle standing times, and additional passengers.

16. A vehicle comprising:
a device, allocated to a road user of the vehicle, configured to send to a server a parameter value acquired over a period of movement between starting and target points of vehicle locomotion, the server configured to compare the value with other values deposited on a first list to report, from a second list, a comparison value to the device.

17. The vehicle as claimed in claim 16, wherein the parameter value is an age of the road user, a weight of the road user, a time needed for a particular distance, a selected route, or a maximum speed.

18. The vehicle as claimed in claim 16, wherein the parameter value is a type of vehicle, a time needed for a particular distance, a fuel consumption for a particular distance, a distance traveled, a maximum speed, vehicle standing times, and additional passengers.

19. The vehicle as claimed in claim 16, wherein the server is further configured to generate a ranking list based on the parameter values.

20. The vehicle as claimed in claim 16, wherein the device includes an app installed to a smartphone.
